(19) United States
(12) Patent Application Publication
(10) Pub. No.: US 2011/0113924 A1
(43) Pub. Date: May 19, 2011

(54) COMPACTING SILICON

(76) Inventors: Frank Asbeck, Bonn (DE); Armin Muller, Freiberg (DE); Stefan Thomas, Freital (DE)

(21) Appl. No.: 13/000,397

(22) PCT Filed: Apr. 21, 2009
(86) PCT No.: PCT/EP2009/002958

§ 371 Date: Dec. 21, 2010

(30) Foreign Application Priority Data
Jul. 1, 2008 (DE) 10 2008 030 724.6
Aug. 26, 2008 (DE) 10 2008 044 688.2

(51) Int. Cl. C22C 1/04; B22F 3/04; B29C 67/02

(52) U.S. Cl. 75/228; 419/68; 425/224

(57) ABSTRACT

In order to compact a blank from silicon powder, the latter is uniaxially pressed in a mold chamber.

### CROSS REFERENCE TO RELATED APPLICATIONS

This application is a United States National Phase application of International Application PCT/EP 2009/002958 and claims the benefit of priority under 35 U.S.C. §119 of German patent application DE 10 2008 030 724.6 filed Jul. 1, 2008 and German patent application DE 10 2008 044 688.2 filed Aug. 28, 2008, the entire contents of which are incorporated herein by reference.

### FIELD OF THE INVENTION

The present invention pertains to a device and a method for producing blanks from a powder, in particular from silicon.

### BACKGROUND OF THE INVENTION

In order, for example, to be able to further process silicon powder produced from monosilane in a deposition process, an increase in the material density and forming are advantageous. For this purpose, a roller compacting method is generally used. A problem here is the contamination of the silicon powder during preparation, in particular during compression. In order to avoid such problems, special rollers which can only be produced expensively are required. Because of the microcrystalline structure and the surface character of the crystallites, the fine-particle silicon, as occurs, for example, during the pyrolytic degradation of monosilane, cannot be converted by simple mechanical compression into a processable material.

### SUMMARY OF THE INVENTION

The invention is therefore based on the object of further developing a device and a method for forming a blank from a powder.

This object is achieved according to the invention by a device for forming a blank from a powder, comprising at least one mold chamber for receiving a powder with a longitudinal axis and cross section extending perpendicular thereto, and a compression mechanism for uniaxial compression of the powder in the at least one mold chamber in the direction of the longitudinal axis. Said object is further achieved according to the invention by a method for producing blanks from a powder, comprising the steps of providing a mold chamber to receive a powder, filling the at least one mold chamber with a powder, compressing the powder in the mold chamber, wherein the powder in the mold chamber is pressed uniaxially for compression. The core of the invention consists in compressing powder in a mold chamber by means of a uniaxial press. It was surprisingly found that pre-compacted powder, for example highly pure silicon powder, could be pressed by means of uniaxial pressing to form suitable blanks.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side view of the device during the pressing process; and

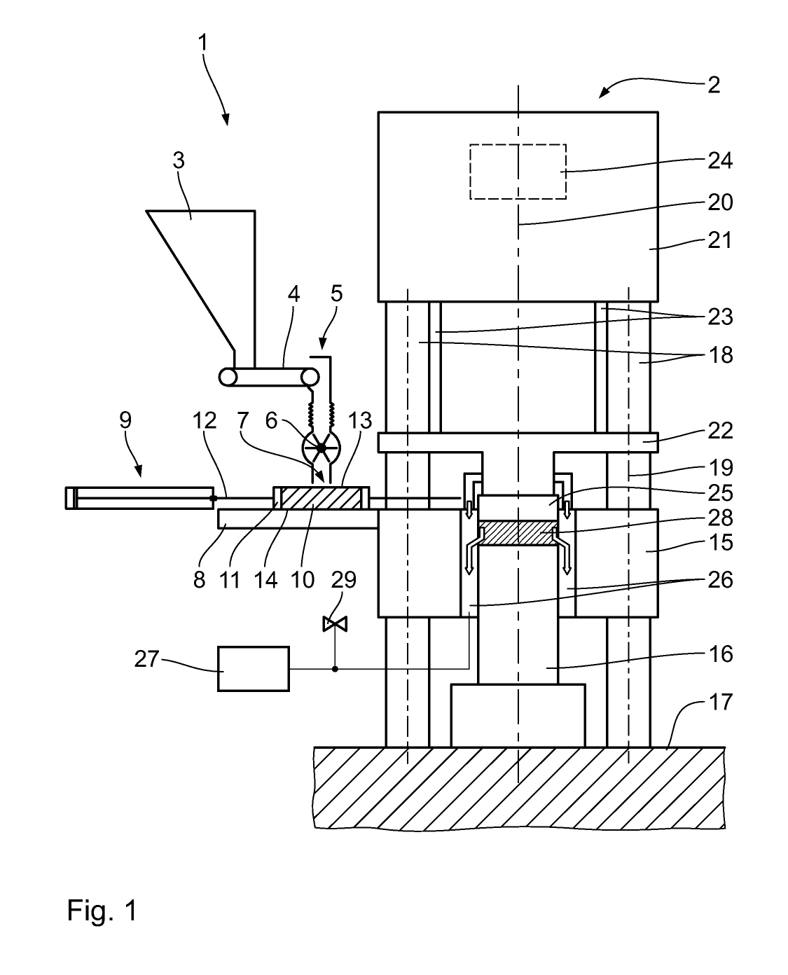

FIG. 2 is a side view of the device with the die moved up.

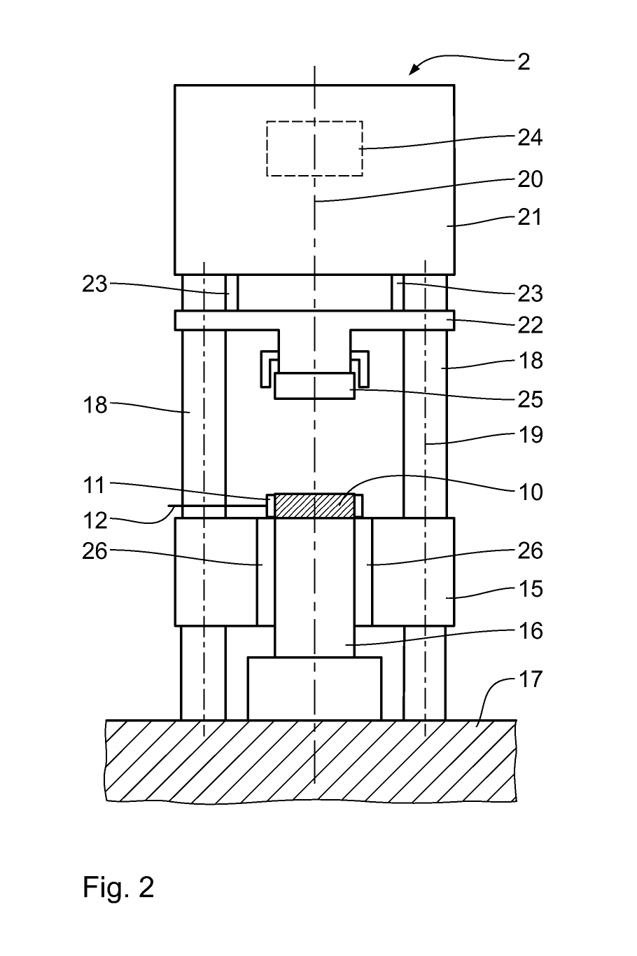

### DESCRIPTION OF THE PREFERRED EMBODIMENTS

A device for forming a blank from a powder, in particular a silicon powder, in particular highly pure silicon powder, comprises a feed mechanism 1 and a compression mechanism 2.

The feed mechanism 1 comprises a filling funnel 3, a conveying element 4 and a pre-compacting unit 5. The pre-compacting unit 5, in turn, has a rotatable, in particular rotatably driveably mounted paddle wheel 6. As an alternative to this, the pre-compacting unit 5 may also have a screw conveyor. The pre-compacting unit 5 has an outlet opening 7, which is arranged above a support table 8.

A feed chamber 10 which can be displaced by a displacement mechanism 9 is horizontally displaceably arranged on the support table 8. The feed chamber 10 has an upper opening 13 and a lower opening 14. It can be filled with the powder to be compacted by means of the feed mechanism 1.

The displacement mechanism 9 has a displacement rod 12 connected to a side wall 11 of the feed chamber 10. The displacement rod 12 may, for example, be hydraulically or pneumatically displaceable. The feed chamber 10 can be pushed in or out of the compression mechanism 2 by means of the displacement mechanism 9. The feed chamber 10 rests on a press bed 15 for introduction into the compression mechanism 2. The press bed 15 has a cavity which extends along the center longitudinal axis 20 centrally and can be closed in a gas-tight manner from below by a lower die 16. The shape of the cavity is precisely adapted for this to the outer dimensions of the lower die 16. The cavity, which is laterally limited by the press bed 15 and from below by the lower die 16, forms a mold chamber 28 that is open at the top.

The press bed 15 can be displaced along a vertical 19 guided by four vertically arranged guide rods 18. The lower die 16 has a center longitudinal axis 20. The center longitudinal axis 20 extends parallel to the vertical 19. The lower die 16 is supported relative to a fixed base 17. On its inner side facing the mold chamber 28, the press bed 15 has a gas-permeable filter insert 26. The filter insert 26 is made of a ceramic material. In particular, it has a silicon fraction. Provided as the material for the filter insert 26 are, in particular, silicon carbide, silicon nitride or a compound of these materials. An evacuation mechanism 27 with a control valve 29 is coupled to the filter insert 26.

Furthermore, the compression mechanism 2 comprises an upper part 21, in which an upper die 22 is mounted, displaceably guided parallel to the vertical 19. The upper die 22 has a die plate 25 at its lower side. At least the die plate 25 is made of a ceramic material. In particular, it has a silicon fraction. Silicon carbide, silicon nitride or silicon dioxide, in particular, are provided as the materials for the die plate 25. The die plate 25 has a cross section perpendicular to the center longitudinal axis 20, which is adapted to the cross section of the mold chamber 28. The lower die 6 is configured accordingly.

The mold chamber 28 has a square cross section. It has an edge length in the range of 40 mm to 500 mm, in particular in the range of 100 mm to 350 mm. As an alternative to this, the mold chamber 28 may have a round cross section with a corresponding diameter. The cross section of the mold chamber 28 is constant in the direction of the center longitudinal axis 20. The mold chamber 28, in the direction of the center longitudinal axis 20, has a height in the range of 20 mm to 500 mm, in particular in the range of 30 mm to 100 mm, in particular in the range of 40 mm to 50 mm.

The mold chamber 28 can be closed in a gas-tight manner by means of the die plate 25 at its upper end. Furthermore, the mold chamber 28 can be loaded by means of the evacuation mechanism 27, also called a negative pressure device, by means of the filter insert 26 with negative pressure in the range of less than 300 mbar, in particular of less than 200 mbar, preferably of less than 100 mbar.

The upper die 22 is coupled, in a force-transmitting manner, to a pressure production mechanism 24, only shown schematically in the figures by means of four force-transmitting displacement elements 23. The pressure production mechanism 24 may be configured mechanically. It comprises, in particular, a reducing gear. Gear wheel rods are, for example, provided as displacement elements 23. As an alternative to this, the pressure production mechanism 24 may also be configured hydraulically with displacement elements 23 configured as hydraulic piston rods.

The volume of the mold chamber 28 can be changed by displacing the upper die 22 by means of the displacement elements 23. The compression mechanism 2 is therefore configured as a press. The pressure which can be exerted by the pressure production mechanism 24 by means of the die plate 25 on the mold chamber 28 is in the range of 1 to 100 kN/cm², in particular in the range of 5 to 15 kN/cm².

The entire device is preferably arranged in a reaction space closed in a gas-tight manner, an inert gas mechanism, not shown in the figures, being provided to replace the oxygen contained in the reaction space by an inert gas. Nitrogen, argon or another inert gas, in particular, are used as the inert gas here.

A method for producing blanks will be described below. The feed chamber 10 is firstly filled with a powder, in particular silicon powder, by means of the feed mechanism 1. The silicon powder to be compressed has a density in the range of 2 to 500 g/dm³. The macroscopic particles of the silicon powder to be compressed have a mean diameter in the range of 0.01 μm to 100 μm, in particular in the range of 0.1 μm to 20 μm. The silicon powder has a purity of at least 99.9%, in particular 99.999%, in particular at least 99.9999999%. The powder is pre-compressed in the pre-compacting unit 5 to a bulk density in the range of 100 to 500 g/dm³, in particular in the range of 300 to 450 g/dm³.

The feed chamber 10 is then pushed with the aid of the displacement mechanism into the compression mechanism 2 until its lower opening 14 aligns with the cavity in the press bed 15. The powder thus arrives in the mold chamber 28, which is limited from below by the lower die 16. After filling the mold chamber 28 with the powder, the feed chamber 10 is pulled out of the compression mechanism 2 again by means of the displacement mechanism 9. The upper die 22 is then guided down along the center longitudinal axis 20 by means of the displacement elements 23 until the die plate 25 closes the mold chamber 28 at the upper end thereof in a gas-tight manner.

The mold chamber 28 is then loaded with negative pressure with the aid of the evacuation mechanism 27. The pressure in the mold chamber 28 is thus reduced to 70 mbar. The degassing lasts between 10 sec and 60 sec, in particular between 30 sec and 45 sec.

Pressure on the upper die 22 with the die plate 25 is then built up by means of the pressure production mechanism 24 in order to uniaxially compact the powder in the mold chamber 28. The pressure exerted by the pressure production mechanism 24 by means of the pressure plate 25 on the mold chamber 28 is in the range of 1 to 100 kN/cm², in particular in the range of 5 to 15 kN/cm². The pressing process lasts between 5 and 60 sec, in particular between 10 and 15 sec. The upper die 22 is then returned again to the upper starting position.

After lowering the press bed 15 by at least an amount corresponding to the height of the mold chamber 28 when pressing the blank, the latter is freely accessible. Obviously, instead of lowering the press bed 15, lifting of the lower die 16 may also be provided.

The blank produced in this manner has a density in the range of 100 g/dm³ to 2000 g/dm³, in particular of more than 1000 g/dm³. It has a purity of at least 99.9%, in particular of at least 99.999%, in particular of at least 99.999999%. The absorbed oxygen fraction is a maximum of 2000 ppm, in particular a maximum of 1000 ppm. The compactate has a fine fraction of below 5%, in particular below 1% of the silicon powder used with a contamination with regard to metals of less than 1 ppm, in particular less than 0.1 ppm. It has a homogeneity in the range of 90% to 100%. The silicon compactate is also characterized by an inner surface in the range of 5 m²/g to 15 m²/g, in particular in the range of 10 m²/g to 13 m²/g. The inner structure of the compactate is characterized by aggregates and/or agglomerates of silicon particles and can be described as follows: silicon particles with a partly coherent crystal structure form a primary structure of 25 to 100 nm in size. Secondary structures of microscopically identifiable clusters of silicon primary particles have dimensions of up to 1 μm. Agglomerated silicon secondary particles come together to form tertiary structures of up to 100 μm, which determine the macroscopic product properties. These are characterized, in particular, by a problem-free ease of stacking and/or flow and an abrasion resistance which is adequately high for the technical requirements, which are advantageous, in particular, for further use of the compactate to produce a silicon melt. It has been shown that the blank produced in this manner can be melted at a temperature of at most 1500° C. to form a homogeneous silicon melt.

While specific embodiments of the invention have been shown and described in detail to illustrate the application of the principles of the invention, it will be understood that the invention may be embodied otherwise without departing from such principles.

1. A device for forming a blank from a powder, comprising:
at least one mold chamber for receiving a powder with
a longitudinal axis and
a cross section extending perpendicular thereto; and
a compression mechanism for uniaxial compression of the powder in the at least one mold chamber in the direction of the longitudinal axis (20).

2. A device according to claim 1, wherein the compression mechanism is configured as a press with a die which can be displaced along the longitudinal axis.

3. A device according to claim 2, wherein the die, perpendicular to the longitudinal axis at a lower end thereof, has a cross section which is adapted to the cross section of the mold chamber.

4. A device according to claim 2, wherein the die is at least partially formed from at least one of a ceramic material a silicon and a silicon compound.

5. A device according to claim 1, wherein the mold chamber has one of the group of a round cross section and a rectangular cross section.

6. A device according to claim 5, wherein the cross section of the mold chamber is constant in the direction of the longitudinal axis.

7. A device according to claim 1, wherein the mold chamber has a diameter or an edge length in the range of 40 mm to 500 mm.

8. A device according to claim 1, wherein the pressure which can be exerted by the compression mechanism on the mold chamber is in the range of 1 to 100 kN/cm².

9. A device according to claim 1, that wherein the mold chamber can be closed in a gas-tight manner.

10. A device according to claim 1, wherein at least one negative pressure mechanism is provided to load the mold chamber with negative pressure.

11. A device according to claim 1, wherein the device is arranged in a reaction space which is closed in a gas-tight manner, an inert gas mechanism being provided to replace the oxygen contained in the reaction space by an inert gas.

12. A method for producing blanks from a powder, the method comprising the following steps:
providing a mold chamber to receive a powder,
filling the at least one mold chamber with a powder,
compressing the powder in the would chamber, wherein the powder in the mold chamber is pressed uniaxially for compression.

13. A method according to claim 12, wherein the mold chamber, before the compression of the powder, is loaded with negative pressure in the range of less than 300 mbar.

14. A method according to claim 12, wherein the compression lasts 5 to 360 seconds.

15. A silicon produced by a method for producing blanks from a powder, comprising the following steps:
providing a mold chamber to receive a powder;
filling the at least one mold chamber with a powder;
compressing the powder in the mold chamber, wherein the powder in the mold chamber is pressed uniaxially for compression, wherein:
the silicon is present in the form of a homogeneous, compressed blank made of a compressed powder;
the silicon has a purity of at least 99.9%
the blank has a mean bulk density in the range of 100 g/dm³ to 2000 g/dm³; and
the blank can be melted at a temperature of at most 1500° C. to form a homogeneous silicon melt.

16. A silicon blank according to claim 15, wherein the powder has primary particles with a mean diameter in the range of 0.01 μm to 100 μm.

17. A silicon blank according to claim 15, wherein the inner structure of the blank comprises at least one of aggregates and agglomerates.

18. A silicon blank according to claim 15, wherein the proportion of absorbed oxygen is less than 2000 ppm.

19. A silicon blank according to claim 15, comprising a fine fraction of less than 5% of the material used.

20. A silicon blank according to claim 15, comprising a contamination with regard to metals of less than 1 ppm.

21. A silicon blank according to claim 15, comprising an inner surface in the range of 5 m²/g to 15 m²/g.

22. A method, comprising:
providing a device comprising at least one mold chamber for receiving a powder with a longitudinal axis and a cross section extending perpendicular thereto, said device comprising a compression mechanism for uniaxial compression of the powder in the at least one mold chamber in the direction of the longitudinal axis;
using the device to form a blank from the powder, wherein the powder to be compressed is silicon powder.

23. A device according to claim 1, wherein the mold chamber has a square cross section.

24. A device according to claim 1, wherein the pressure which can be exerted by the compression mechanism on the mold chamber is in the range of 5 to 15 kN/cm².

25. A method according to claim 12, wherein the mold chamber, before the compression of the powder, is loaded with negative pressure in the range of less than 200 mbar.

26. A method according to claim 12, wherein the mold chamber, before the compression of the powder, is loaded with negative pressure in the range of less than 100 mbar.

27. A method according to claim 12, wherein the compression lasts 10 to 60 seconds.

28. A method according to claim 12, wherein the compression lasts less than 20 seconds.

29. A silicon blank according to claim 15, wherein the powder has primary particles with a mean diameter in the range of 0.1 μm to 20 μm.

30. A silicon blank according to claim 15, wherein the proportion of absorbed oxygen is less than 1000 ppm.

31. A silicon blank according to claim 15, wherein the proportion of absorbed oxygen is less than 700 ppm.

32. A silicon blank according to claim 15, comprising a fine fraction of less than 1% of the material used.

33. A silicon blank according to claim 15, comprising a contamination with regard to metals of less than 0.1 ppm.

34. A silicon blank according to claim 15, comprising an inner surface in the range of 10 m²/g to 13 m²/g.
